(19) United States
(12) Patent Application Publication
(10) Pub. No.: US 2007/0151431 A1
(43) Pub. Date: Jul. 5, 2007

(54) Food cutting machine

(75) Inventors: Roland Bassler, Balingen (DE); Olaf Gauss, Dautmergen (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Bizerba GmbH & Co. KG, Balingen (DE)

(21) Appl. No.: 11/638,906

(22) Filed: Dec. 14, 2006

(30) Foreign Application Priority Data
Dec. 16, 2005 (DE) 10 2005 062 501.0

(51) Int. Cl. B26D 1/18; B26D 7/06; B26D 5/08

(52) U.S. Cl. 83/113; 83/167; 83/471.2; 83/485; 83/490; 83/932

(57) ABSTRACT

A food cutting machine, in particular for bakery products, is provided, comprising a driven circular blade, a movable blade arm, on which the circular blade is rotatably disposed by means of a bearing device, wherein the circular blade by means of movement of the blade arm is engageable into material to be cut, and a covering device, which is disposed on the blade arm and by which the bearing device is covered transversely of an axis of rotation of the circular blade, wherein the covering device has a wedge region that is engageable into material to be cut, and wherein beside the wedge region a free region is provided, wherein the distance from the axis of rotation to an edge of the free region on the covering device is smaller than the distance between the axis of rotation and the edge of the wedge region.

The present disclosure relates to the subject matter disclosed in German application number 10 2005 062 501.0 of Dec. 16, 2005, which is incorporated herein by reference in its entirety and for all purposes.

### BACKGROUND OF THE INVENTION

The invention relates to a food cutting machine, in particular for bakery products, comprising a driven circular blade, a movable blade arm, on which the circular blade is rotatably disposed by means of a bearing device, wherein the circular blade by means of movement of the blade arm is engageable into material to be cut, and a covering device, which is disposed on the blade arm and by which the bearing device is covered transversely of an axis of rotation.

From DE 37 06 485 A1 a slice-cutting and -separating machine for bread, cheese and the like is known, which comprises a revolving blade rocker with revolving blade that is free on both sides and travels with its own revolving-blade pivot through the medium that is to be cut and/or separated.

From EP 0 955 137 A2 a machine for cutting a material rope into slices with a cutting device is known, which comprises a circular blade revolving on a rotatable drive arm, a feed device for the material strand to be cut, and a receiving device for the cut slices. The cut slices are movable away from the cutting device, wherein a contact surface together with the feed direction of the material strand forms such an angle that between the cut slices and the cut surface of the material strand a wedge-shaped gap is formed for the drive arm of the cutting device.

From EP 0 169 399 B1 a slicing/cutting apparatus for food products, in particular for cutting sausage, ham, bacon, meat, cheese and the like is known, comprising a driven, flat-disk-shaped circular blade, which is connected by an eccentric rocker to a main drive and rotates on a circular path, as well as a product feed apparatus. Associated with the circular blade on the opposite side to the feed apparatus is a driven covering element, which rotates with the circular blade on the circular path thereof and of which the diameter is smaller than the diameter of the circular blade and the rotational speed differs from the rotational speed of the circular blade.

### SUMMARY OF THE INVENTION

In accordance with the invention, a food cutting machine is provided, for which the maintenance effort is reduced.

In accordance with the invention, the covering device has a wedge region that is engageable into material to be cut. By means of the wedge region a cut slice may be pushed away from a cutting position in order in particular to keep free a guide region for the blade arm during a return motion of the blade arm, thereby allowing material to be cut to be fed for the next cutting operation. For example, when cutting moist bread, the problem may arise that residues of material to be cut are left clinging to the circular blade. By means of the wedge region this clinging may be minimized because, as the circular blade engages further into the material to be cut, this wedge region may act upon the material to be cut.

Beside and in particular next to the wedge region a free region is provided, wherein the distance (spacing) from the axis of rotation to an edge of the free region on the covering device is smaller than the distance (spacing) between the axis of rotation and the edge of the wedge region. The circular blade may therefore be cleaned more easily at the free region. Furthermore, by manually rotating the circular blade during a cleaning operation, waste from the material to be cut and from the cut material that is situated between the covering device and the circular blade may be brought out through the free region.

A plurality of discrete slide bearings may be provided for the carriage mounting of the circular blade on the covering device.

By means of the slide bearings the circular blade may be supported against the covering device. As a result, a gap between the covering device and the circular blade may be kept small, so that in turn the penetration of waste from material to be cut and from cut material between circular blade and covering device may be minimized.

By virtue of providing discrete (spaced-apart) slide bearings, the slide friction surface between the circular blade and the bearing device may be minimized. The corresponding slide bearings are easy to manufacture and position on the food cutting machine.

By virtue of providing discrete slide bearings, these bearings are spaced apart from one another. It is therefore possible for waste from the material to be cut and from the cut material that has passed between the covering device and the circular blade to be brought out during a cleaning operation, for example by manually rotating the circular blade. The discrete slide bearings form as-it-were a “conveying path” between the slide bearings, by means of which it is also possible to prevent an accumulation of waste from the material to be cut and from the cut material.

In particular, at least three slide bearings are provided. In principle, for adequate support of the circular blade three slide bearings are sufficient.

In one form of construction, at least five slide bearings and in particular precisely five slide bearings are provided. This for example also easily makes it possible to form between adjacent slide bearings by means of an inset a free region that facilitates the cleaning of the circular blade and of the blade arm in the region of the circular blade.

It is advantageous if a slide bearing comprises a slide element, against which the circular blade rests. The slide element is manufactured from an appropriate material such as for example a polymer material, which has a low coefficient of sliding friction for the circular blade.

In particular, the slide element is positioned in an associated receiver. Such a slide bearing is easy to manufacture. The receiver is manufactured for example by a stamping operation on the covering device. The corresponding slide element is situated loosely in the receiver and retained in the receiver by the fixing of the circular blade to the blade arm. During the rotation of the circular blade, the slide element may co-rotate in its receiver in order in turn to keep the friction low.

In particular, the receiver is disposed on the covering device. This allows the use of a circular blade with a flat surface.

A receiver may be formed in a simple manner by means of a recess in the covering device. The recess is manufactured for example by means of an inset as a result of stamping or the like.

It is quite particularly advantageous if the slide element is mounted loosely on the associated receiver. For example, a slide element is inserted loosely into the receiver and retained in the receiver axially by means of the circular blade. This allows the friction to be kept low.

For example, a slide element is designed as a ring or disk and the contour of the receiver is adapted to the contour of the slide element.

It is advantageous if the wedge region is designed in such a way that the circular blade is engageable by more than half its diameter into material to be cut. Thus, even material to be cut that has large transverse dimensions, such as for example loaves of coarse rye bread, may be cut into slices.

It is advantageous if the wedge region extends over an angular range of more than 90° in order to allow the circular blade to engage by more than half its diameter.

It is further advantageous if the wedge region extends over an angular range of less than 180°. This allows the provision of a free region that facilitates the cleaning of the circular blade and optionally of the blade arm.

In particular, the wedge region lies in an angular range of between 100° and 150°. This allows the circular blade to engage by more than half its diameter into material to be cut and a free region is provided for the facilitated cleaning of the circular blade.

It is advantageous if the wedge region has an outer edge that is disposed at a spacing and set back from the cutting edge. This allows the cutting edge to engage into material to be cut in order to carry out a cutting operation. The wedge region may then, upon further penetration of the blade arm, act upon cut material in order to push it in particular away from the circular blade and hence free up the circular blade.

In particular, the wedge region extends at an acute angle to the circular blade in order to allow such a pushing-away.

It may be provided that the covering device at least in the wedge region has a surface with non-stick properties. This reduces the clinging of material to be cut and/or of cut material to the blade arm.

The covering device has a wedge region that extends over an angular range of more than 90° and less than 150°. This allows the provision of a free region that facilitates the cleaning of the circular blade. It is also impossible for waste from material to be cut and/or from cut material to penetrate into the corresponding free region because it is a free space.

In an advantageous manner, the free region is disposed opposite a front side of the covering device that in the course of the movement of the blade arm during the cutting operation first engages into material to be cut. There is therefore no need to provide a wedge effect on the blade arm in the vicinity of the free region, with the result that the free region for facilitating the cleaning may be realized in a simple manner.

In particular, the covering device has a lateral inset for forming the free region. By means of a corresponding cutout the cleaning of the circular blade may be facilitated. In particular, cleaning is possible without disassembly of the circular blade. Thus, during a cleaning operation an operator may clean the blade arm on the circular blade plus the circular blade without any need for a service engineer. It is therefore easily possible to carry out cleaning on a, for example, daily basis.

Advantageously, a first slide bearing is disposed in the vicinity of a first end of the free region and a second slide bearing is disposed in the vicinity of a second end of the free region. By means of the slide bearings the circular blade may be supported in the vicinity of the free region against the covering device. Cleaning of and around these slide bearings may moreover be carried out easily via the free region.

For example, the free region has an edge region that extends at least approximately parallel to a longitudinal direction of the blade arm. Such a free region is easy to construct.

It may further be advantageous when an edge region of the free region at least approximately follows the contour of a slide bearing. This allows easy cleaning in the vicinity of the slide bearing or slide bearings. What is more, waste from material to be cut and/or from cut material that has penetrated between the circular blade and the covering device may be brought out into the free region, for example by manual rotation of the circular blade.

On the blade arm a torque transmission device is preferably disposed for transmitting torque from a drive to the circular blade. A drive for the circular blade and the circular blade may therefore be positioned at a spacing from one another. It is then easily possible to realize a “cantilever circular blade” with a free cutting edge. Such a circular blade may engage into material to be cut and in particular engage to a large depth. This then makes it possible for example to cut material that has large transverse dimensions, such as loaves of coarse rye bread.

The torque transmission device is advantageously covered at least partially by the covering device. In this way, the torque transmission device is outwardly protected against the penetration of waste from the material to be cut. What is more, the material to be cut is protected against contamination by lubricant of the torque transmission device.

For example, the blade arm is pivotable and/or movable in at least one linear direction in order by means of movement of the blade arm to be able to carry out a cutting operation.

In one form of construction, the blade arm is disposed on a displaceable carriage. In particular, the displaceable carriage is displaceable in a single linear direction. It is therefore possible to realize a food cutting machine and in particular a bread slicing machine that has low height dimensions but may be used also to cut material that has large transverse dimensions, such as for example loaves of coarse rye bread.

In particular, a feed device for material to be cut is provided for conveying material to be cut into a cutting position. It is therefore possible to realize for example automatic slicing of the material to be cut. The forward motion of the feed device for conveying the material to be cut may be realized by the motion of the blade arm (for example a swiveling motion or a lifting motion) in order to obtain automatic slicing. Depending on adaptation of the conveying of the material to be cut by means of the feed device and adaptation of the blade motion, the slice thickness may be adjusted.

For example, a guide gap is provided, in which the blade arm is movable. In this way, a slicing of material to be cut may be effected in a simple manner.

It is quite particularly advantageous if a cleaning position for the circular blade is provided, in which the circular blade is not motor-operable. In this way, safe risk-free cleaning of the circular blade is possible. It is in particular provided that the circular blade in the cleaning position is manually rotatable.

The following description of preferred forms of construction serves in conjunction with the drawings to provide a detailed explanation of the invention.

### BRIEF DESCRIPTION OF THE DRAWINGS

FIG. 1 a diagrammatic plan view of an embodiment of a food cutting machine, in particular a bread slicing machine;

FIG. 2 a perspective view of an embodiment of a blade arm;

FIG. 3 a partial view of the blade arm according to FIG. 2 with a partial view of a torque transmission device;

FIG. 4 a plan view of the blade arm according to FIG. 2;

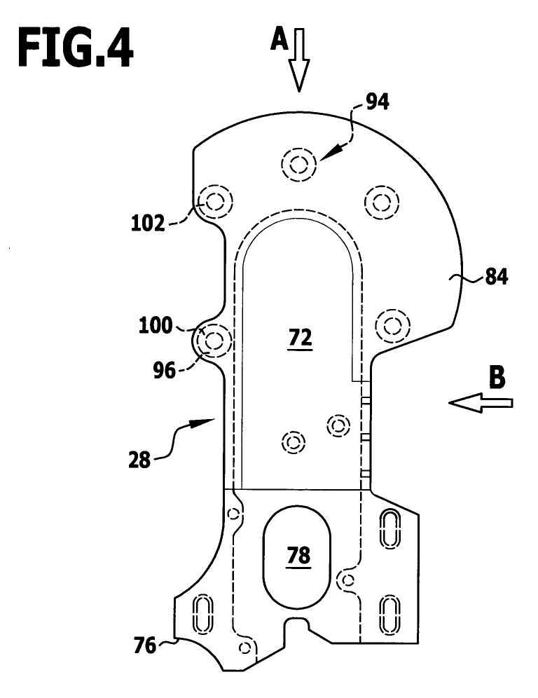

FIG. 5 a view of the blade arm according to FIG. 4 in direction A; and

FIG. 6 a view of the blade arm according to FIG. 4 in direction B.

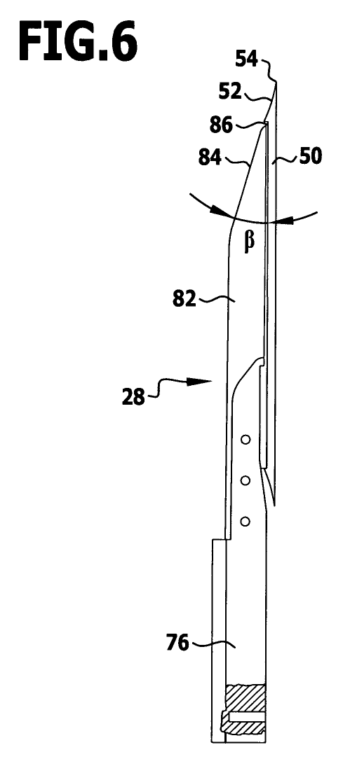

### DETAILED DESCRIPTION OF THE INVENTION

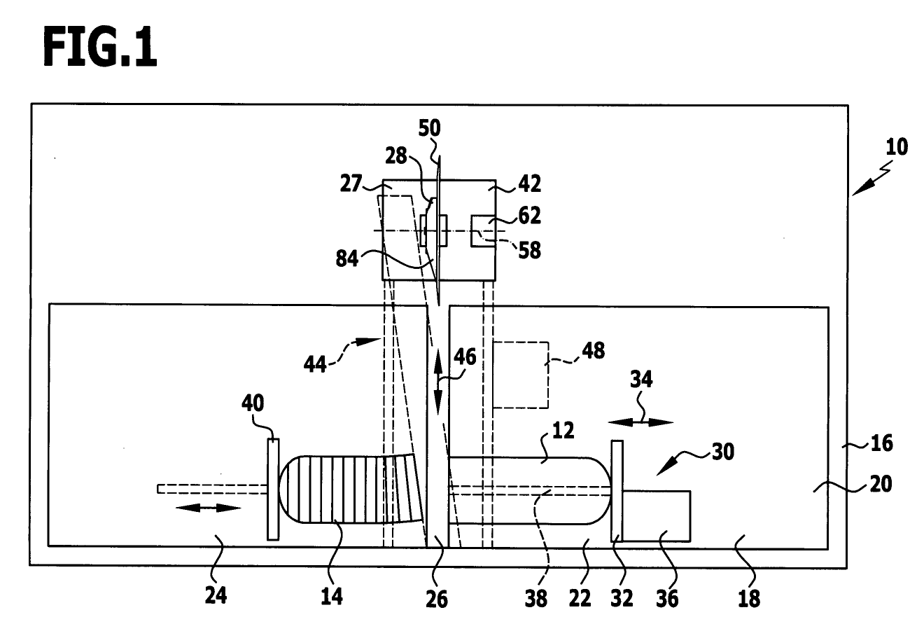

An embodiment of a food cutting machine according to the invention that is shown in FIG. 1 and denoted there by 10 is used to cut bakery products and in particular loaves of bread 12 as material to be cut. A loaf of bread 12 may be cut by means of such a bread slicing machine into slices 14.

The food cutting machine 10 comprises a housing 16, on which a receiver 18 for material to be cut is formed. The material receiver 18 has a smooth surface 20, for example of a metal material, along which the material to be cut (for example the loaf of bread 12) as well as cut material after cutting may be displaced. The material receiver 18 comprises a first region 22 and a second region 24. The first region 22 and the second region 24 are separated by a guide gap 26, in which a movable blade arm 28 is guided. The first region 22 of the material receiver 18 receives material to be cut 12. The second region 24 of the material receiver 18 receives cut material, for example the slices 14 cut from the loaf of bread 12.

The food cutting machine 10 comprises a feed device 30, by means of which material to be cut 12 may be conveyed into a cutting position. The cutting position is defined by the guide gap 26. For opening and closing the guide gap 26 a pusher 27 is provided. The feed device 30 comprises for example a pusher 32, which is displaceable longitudinally in a direction 34. For actuating the movement of the pusher 32 a drive 36 is provided, which acts upon the pusher 32. The drive 36 may be for example a belt drive or the like.

The pusher 32 is guided on a guide 38.

Guided in a linearly displaceable manner on the second region 24 is a pusher 40, against which one end of the cut material rests.

The blade arm 28 is disposed on a carriage 42, which is guided in a linearly displaceable manner in a direction 46 on a guide 44. For actuating the movement of the carriage 42 a drive 48 is provided.

By means of the carriage 42 the blade arm 28 may execute a reciprocating motion in the guide gap 26, i.e. it may move back and forth in the guide gap 26 and, in so doing, effect cutting operations. By virtue of a suitable setting of the rate of feed of the feed device 30 adapted to the frequency of reciprocation of the blade arm 28, it is possible to set the cutting thickness, i.e. the thickness of the cut slices 14.

In particular, a loaf of bread 12 may be automatically cut into slices 14 or halved or quartered. For this purpose, the loaf of bread 12 is inserted between the pushers 40 and 32. By means of the adapted motion of the pusher 32 and the reciprocating motion of the blade arm 28 an automatic slicing of the loaf of bread 12 is effected.

The housing 16 is of a closed design with one or more doors for inserting the material to be cut 12 and for removing cut material 14. Preferably, a cutting operation may be carried out only when the door or doors are closed.

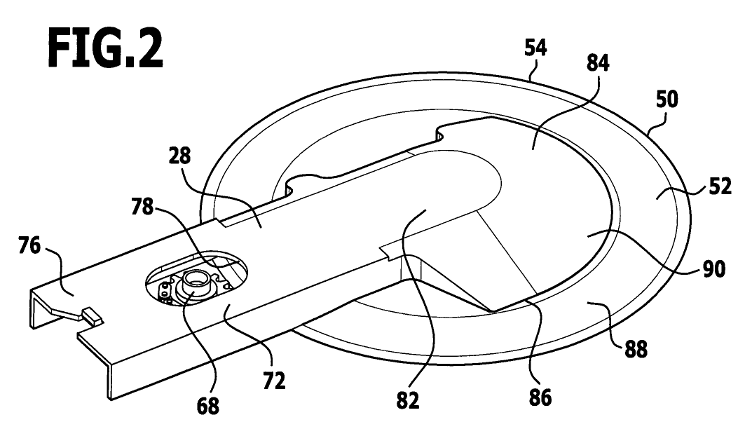

Disposed on the blade arm 28 is a circular blade 50 (FIG. 2). This circular blade has a substantially flat side 52 with a “slight” concavity facing the blade arm 28. It has a cutting edge 54, which is designed in such a way that the appropriate material to be cut 12 is cuttable.

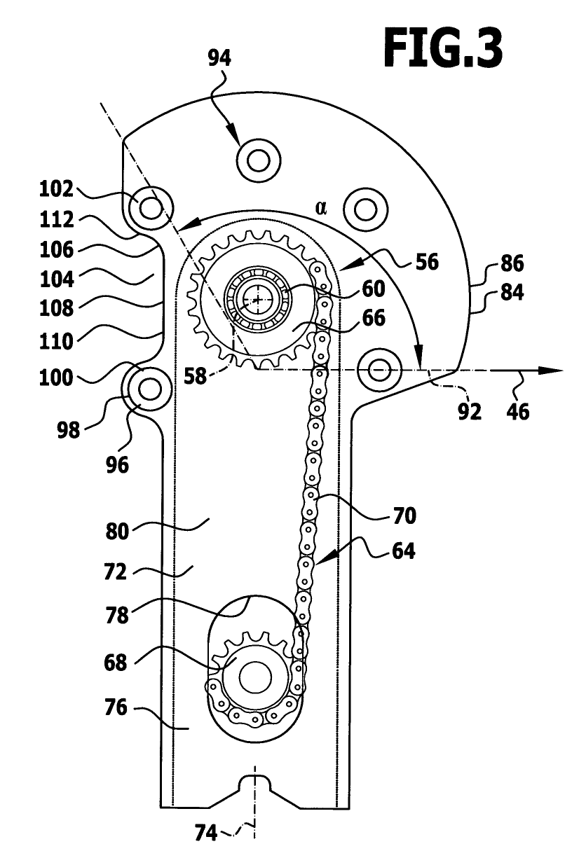

The circular blade 50 is mounted rotatably about an axis of rotation 58 (FIG. 3) on the blade arm 28 by means of a bearing device 56. The bearing device 56 comprises for example a ball bearing 60 such as a grooved ball bearing, by means of which the axis of rotation 58 is defined.

A drive 62 for the circular blade 50 is disposed on the carriage 42 outside of the blade arm 28. The torque of the drive 62 is transmitted by a torque transmission device 64 through the blade arm 28 to the circular blade 50 for setting it in rotation. The torque transmission device 64 comprises for example a first drive wheel 66, which is designed for example as a gear wheel.

The first drive wheel 66, when the circular blade 50 is positioned on the blade arm, is connected in a rotationally fixed manner to the circular blade 50. An axis of rotation of the first drive wheel 66 coincides with the axis of rotation 58 of the circular blade 50. The torque transmission device 64 further comprises a second drive wheel 68, for example in the form of a gear wheel. By means of the drive 62 the second drive wheel 68 is set in rotation. The torque is transmitted from the second drive wheel 68 to the first drive wheel 66 by means of a transmission device 70, such as for example a chain or a belt.

Depending on the configuration of the first drive wheel 66 and the second drive wheel 68, a decrease or an increase of the rotational speed may be achieved. In the embodiment illustrated in FIG. 3, the second drive wheel 68 has a smaller diameter than the first drive wheel 66. As a result, a rotational speed decrease for the first drive wheel 66 is achieved, i.e. the circular blade 50 rotates at a lower angular velocity than the second drive wheel 68.

The blade arm 28 comprises a longitudinal element 72 that extends in a longitudinal direction 74. The torque transmission device 64 is disposed on the longitudinal element 72. The longitudinal element 72 is fastened by an end region 76 tightly and in particular immovably to the carriage 42.

The longitudinal element 72 has a recess 78, behind which the second drive wheel 68 is at least partially disposed in order to allow a coupling to the drive 62.

The torque transmission device 64 comprising the first drive wheel 66, the second drive wheel 68 and the transmission device 70 is disposed in a receiving space 80 of the blade arm 28. This receiving space 80 is covered in an upward direction, i.e. transversely to the axis of rotation 58, by a covering device 82. As a result, the torque transmission device 64 is disposed in a protected manner in the blade arm 28.

The covering device 82 comprises a wedge region 84, which is used to partially cover the blade. The wedge region extends over an angular range α (FIG. 3) that is more than 90° and less than 150°. In the illustrated embodiment, the wedge region 84 extends over an angle α of ca. 120°.

The wedge region 84 forms an upper end of the blade arm 28 that is remote from the carriage 42.

The wedge region 84 has an outer edge 86 (extending in the angular range α), which is disposed at a spacing and set back from the cutting edge 54. An annular region 88 of the circular blade therefore lies between the outer edge 86 and the cutting edge 54 of the circular blade 50. The annular region 88 is so dimensioned that, on the one hand, upon engagement of the circular blade 50 into material to be cut 12 an adequate cutting action is achieved and, on the other hand, the area of contact of the side 52 with the material to be cut 12 is kept low. This reduces the risk of material to be cut clinging to the circular blade 50. The problem of the clinging of material to be cut is particularly relevant when cutting bread, and in particular bread that is still warm.

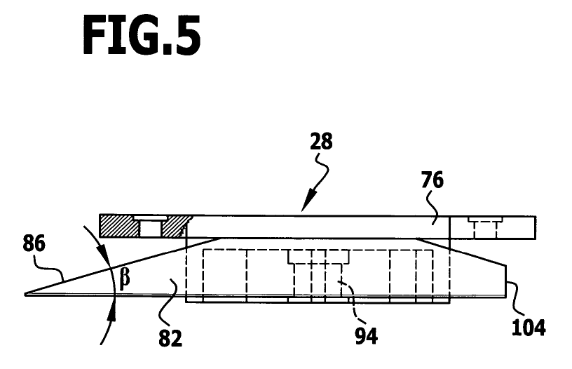

The wedge region 84 runs towards the circular blade 50, i.e. towards the side 52 thereof, at an acute angle β (FIG. 5) that is for example in the order of magnitude of 15°.

When the circular blade 50 by means of the movement of the blade arm 28 engages into material to be cut 12, then, as indicated in FIG. 1, cut material 14 may be displaced by the wedge region 84 away from the circular blade 50 in the direction 24, i.e. the wedge region 84 by means of the movement of the carriage 42 in the direction 46 pushes cut material 14 away from the circular blade 50. (In FIG. 1 this push-away direction is to the left.)

It may be provided that a surface 90 of the wedge region has non-stick properties in relation to the material to be cut 12. For example, a non-stick coating is provided.

The region of the blade arm 28 that is the first to engage into the material to be cut 12 upon engagement of the circular blade 50 is provided with the wedge region 84. For example, a line 92, which is at right angles to the longitudinal direction 74 of the blade arm 28 and cuts and/or touches the outer edge 86 of the wedge region 84 at one end, is parallel to the direction 46.

The outer edge 86 in the angular range a may be at least approximately parallel to the course of the cutting edge 54 of the circular blade 50.

The fact that the wedge region 84 extends over an angular range of more than 90° allows the circular blade 50 to engage by more than half the diameter of the circular blade 50 into material to be cut 12.

For carriage mounting of the circular blade 50 on the covering device 82, spaced-apart discrete slide bearings 94 are provided. In particular, at least three slide bearings 94 are provided. In the illustrated embodiment, five slide bearings 94 are provided. The slide bearings 94 are disposed in this case on the wedge region 84.

One slide bearing 94 (such as for example a first slide bearing 96) comprises a receiver 98, which is disposed by means of a recess, for example in the form of an indentation or an inset, on the covering device 82. Seated loosely in the receiver 98 is a slide element 100 made of an appropriate material, such as for example a heavy-duty polymer. The slide element 100 with one surface is in contact with, and thereby supports, the circular blade 50.

The described first slide bearing 96 is disposed outside of the wedge region 84 on the blade arm 28. Adjacent thereto is a second slide bearing 102, which is of a fundamentally identical design. Between the first slide bearing 96 and the second slide bearing 102 there is a free region 104 (free space) that is formed for example by an inset 106 of the covering device 82. A spacing of an edge 108 of this inset 106 from the axis of rotation 58 is in said case smaller than the spacing between this axis of rotation and the outer edge 86 of the wedge region 84 of the covering device 82.

An edge region 110 of the inset 106 is in said case at least approximately parallel to the longitudinal direction 74. Further edge regions 112 at least approximately follow the contour shape of the first slide bearing 96 and the second slide bearing 102.

The free region 104 lies opposite a front area of the wedge region 84 that is the first area of the wedge region 84 to engage into the material to be cut 12 when a cutting operation is being effected.

The free region 104 at the inset 106 facilitates the cleaning of the circular blade 50.

Between the covering device with its outer edge 86 and the circular blade 50 there is a small gap; this gap is defined substantially by the support on the slide bearings 94. Material to be cut and in particular waste from cut material may pass into the gap. By virtue of the free region 104 cleaning is facilitated; access is afforded to the area around the slide bearings 96 and 102, the area into which waste from material to be cut and from cut material may penetrate is reduced, and the removal of penetrated waste from material to be cut and/or from cut material is facilitated.

The food cutting machine 10 operates as follows:

Material to be cut 12 is inserted between the pushers 32 and 40. After closure of the housing, the food cutting machine 10 is switched on. As a result, the drive 36 of the feed device, the drive 48 for the carriage 42 and the drive 62 for the circular blade 50 are switched on. In synchronism with the reciprocating motion of the blade arm 28 in the guide gap and the carriage 42, material to be cut is fed by means of the feed device 30 to the guide gap 26, which defines a cutting position. The wedge region 84 of the covering device 82 of the blade arm 28 pushes cut slices 14 away from the guide gap 26, thereby freeing the guide gap 26 for the return travel of the carriage 42 and allowing the material to be cut to be advanced by the feed device 30 for the next cut.

The guide gap 26 is closed and opened by means of the pusher 27. The pusher 27 is disposed parallel to the material receiver 18 and positioned directly under a receiving plane for material to be cut. The pusher 27 is coupled in particular mechanically to the reciprocating motion of the blade arm 28 by a suitable mechanism (not shown in the drawings). The pusher 27 extends diagonally across the guide gap 26.

The slice thickness of the cut slices 14 is adjustable by adapting the reciprocating motion of the blade arm 28 and the rate of feed of the feed device 30.

For cleaning the blade arm 28, it is moved into a cleaning position. In the cleaning position, a control unit ensures that the circular blade may not be driven. The cleaning position is for example a blade arm position, in which the carriage 42 is approximately midway between the reversal points of its reciprocating motion. A cleaning operation may be carried out via the free region 104. The free region 104 is a cleaning cutout that allows easier cleaning of the intermediate space between the covering device 82 and the circular blade 50, there being no need to disassemble the circular blade 50. For example, waste from material to be cut and from cut material may be brought out of the intermediate space by manual rotation of the circular blade 50. It is then easily possible to carry out daily cleaning without having to disassemble the circular blade. This in turn allows an operator of the food cutting machine 10 to carry out such a, for example daily, cleaning operation.

1. Food cutting machine, in particular for bakery products, comprising:
a driven circular blade;
a movable blade arm, on which the circular blade is rotatably disposed by means of a bearing device, wherein the circular blade by means of movement of the blade arm is engageable into material to be cut; and
a covering device, which is disposed on the blade arm and by which the bearing device is covered transversely of an axis of rotation of the circular blade;
wherein the covering device has a wedge region that is engageable into material to be cut; and
wherein beside the wedge region a free region is provided, wherein the distance from the axis of rotation to an edge of the free region on the covering device is smaller than the distance between the axis of rotation and the edge of the wedge region.

2. Food cutting machine according to claim 1, wherein a plurality of discrete slide bearings are provided for the sliding bearing mounting of the circular blade on the covering device.

3. Food cutting machine according to claim 2, wherein at least three slide bearings are provided.

4. Food cutting machine according to claim 2, wherein at least five slide bearings are provided.

5. Food cutting machine according to claim 1, wherein the at least one slide bearing comprises a slide element, against which the circular blade rests.

6. Food cutting machine according to claim 5, wherein the at least one slide element is positioned in an associated receiver.

7. Food cutting machine according to claim 6, wherein the receiver is disposed on the covering device.

8. Food cutting machine according to claim 6, wherein the receiver is formed by a recess on the covering device.

9. Food cutting machine according to claim 6, wherein the at least one slide element is mounted loosely on the associated receiver.

10. Food cutting machine according to claim 6, wherein the at least one slide element takes the form of a ring or disk.

11. Food cutting machine according to claim 1, wherein the wedge region is designed in such a way that the circular blade is engageable by more then half its diameter into material to be cut.

12. Food cutting machine according to claim 1, wherein the wedge region extends over an angular range α of more than 90°.

13. Food cutting machine according to claim 1, wherein the wedge region extends over an angular range α of less than 180°.

14. Food cutting machine according to claim 1, wherein the wedge region extends over an angular range α of between 100° and 150°.

15. Food cutting machine according to claim 1, wherein the wedge region has an outer edge that is disposed at a distance and set back from the cutting edge.

16. Food cutting machine according to claim 1, wherein the wedge region runs at an acute angle β towards the circular blade.

17. Food cutting machine according to claim 1, wherein the covering device at least in the wedge region has a surface with non-stick properties.

18. Food cutting machine according to claim 1, wherein the wedge region extends over an angular range α of more than 90° and less than 150°.

19. Food cutting machine according to claim 1, wherein the free region is disposed opposite a front side of the covering device that first engages into material to be cut in the course of movement of the blade arm during the cutting operation.

20. Food cutting machine according to claim 1, wherein the covering device has a lateral inset for forming the free region.

21. Food cutting machine according to claim 1, wherein a first slide bearing is disposed in the vicinity of a first end of the free region and a second slide bearing is disposed in the vicinity of a second end of the free region.

22. Food cutting machine according to claim 1, wherein the free region has an edge region that extends at least approximately parallel to a longitudinal direction of the blade arm.

23. Food cutting machine according to claim 21, wherein an edge region of the free region at least approximately follows the contour of a slide bearing.

24. Food cutting machine according to claim 1, wherein disposed on the blade arm is a torque transmission device for transmitting torque from a drive to the circular blade.

25. Food cutting machine according to claim 24, wherein the torque transmission device is at least partially covered by the covering device.

26. Food cutting machine according to claim 1, wherein the blade arm is at least one of pivotable and movable in at least one linear direction.

27. Food cutting machine according to claim 1, wherein the blade arm is disposed on a displaceable carriage.

28. Food cutting machine according to claim 1, wherein a feed device for material to be cut is provided for conveying material to be cut into a cutting position.

29. Food cutting machine according to claim 1, wherein a guide gap is provided, in which the blade arm is movable.

30. Food cutting machine according to claim 1, wherein a cleaning position for the circular blade is provided, in which the circular blade is not motor-operable.
